(19) United States
(12) Patent Application Publication
(10) Pub. No.: US 2013/0147262 A1
(43) Pub. Date: Jun. 13, 2013

(54) Cross-Links for a Track of a Tracked Vehicle

(71) Applicant: Francois Paquet, Granby Quebec (CA)

(72) Inventor: Francois Paquet, Granby Quebec (CA)

(73) Assignee: Rolic Invest SARL

(21) Appl. No.: 13/641,586

(22) PCT Filed: Apr. 16, 2010
(86) PCT No.: PCT/CA2010/000612

§ 371 Date: Feb. 15, 2013

Related U.S. Application Data
(63) Continuation-in-part of application No. 12/738,112, filed on Jul. 12, 2010.
(60) Provisional application No. 60/980,166, filed on Oct. 15, 2007.

(51) Int. Cl. B62D 55/26

(52) U.S. Cl. CPC B62D 55/26
USPC 305/180

(57) ABSTRACT

A cross-link for a track of a tracked vehicle, such as a tracked carrier vehicle. The track comprises a plurality of belts spaced apart to accommodate a plurality of wheels of the tracked vehicle, the belts having a ground-facing side for facing the ground. The cross-link comprises an elongate member for mounting to the belts to interconnect the belts. The elongate member has a belt-engaging face contacting the belts on the ground-facing side when the elongate member is mounted to the belts. The cross-link also comprises a sole mountable to the elongate member. The sole comprises a ground-engaging portion for engaging the ground. A ground contact area of the sole may be substantially different from a projected area of the elongate member onto the ground. For example, a length of the ground-engaging portion of the sole may be substantially different from a length of the elongate member.

### FIELD OF THE INVENTION

The invention relates generally to tracks for tracked vehicles and, more particularly, to cross-links for such tracks.

### BACKGROUND

Certain types of tracked vehicles, such as tractors and carriers used in various industrial or military applications, are propelled by a pair of tracks each comprising belts that are interconnected by a series of cross-links distributed longitudinally along the track.

Cross-links are typically made of metal, such as so-called “D-dent” cross-links and “flat track” cross-links which are forged into shape. These cross-links may be suitable when a tracked vehicle on which they are provided is on soft terrain (e.g., earth, mud). However, due to the tracked vehicle's weight, they are often unsuitable and/or unacceptable for use on hard surfaces (e.g., paved surfaces) as they tend to damage such hard surfaces.

Some flat track cross-links have been permanently embedded in a rubber envelope to reduce their impact on hard surfaces. However, in view of the rubber envelope's permanent presence, these cross-links often prove inadequate in situations or applications where enhanced traction of metallic cross-links is desired or required, such as on very soft terrain.

Other flat track cross-links have been provided with urethane shoes bolted thereon to reduce their impact on hard surfaces. However, the urethane shoes, which are massive and have substantially the same length as the cross-links, can be detrimental to traction in some cases. Furthermore, stones and other small hard objects typically become easily trapped in bolt holes of the urethane shoes such that use of a tracked vehicle equipped with such cross-links on a hard surface can still inflict damage on that surface.

Accordingly, there is a need for improvements in cross-links for tracks of tracked vehicles.

### SUMMARY OF THE INVENTION

According to a broad aspect, the invention provides a cross-link for a track of a tracked vehicle. The track comprises a plurality of belts spaced apart to accommodate a plurality of wheels of the tracked vehicle, the belts having a ground-facing side for facing the ground. The cross-link comprises an elongate member for mounting to the belts to interconnect the belts. The elongate member has a belt-engaging face contacting the belts on the ground-facing side when the elongate member is mounted to the belts. The elongate member has a length. The cross-link also comprises a sole mountable to the elongate member. The sole comprises a ground-engaging portion for engaging the ground. The ground-engaging portion of the sole has a length. The length of the ground-engaging portion of the sole is substantially different from the length of the elongate member.

According to another broad aspect, the invention provides a sole for a cross-link of a track of a tracked vehicle. The track comprises a plurality of belts spaced apart to accommodate a plurality of wheels of the tracked vehicle, the belts having a ground-facing side for facing the ground. The cross-link comprises an elongate member for mounting to the belts to interconnect the belts. The elongate member has a belt-engaging face contacting the belts on the ground-facing side when the elongate member is mounted to the belts. The elongate member has a length. The sole is mountable to the elongate member and comprises a ground-engaging portion for engaging the ground. The ground-engaging portion of the sole has a length. The length of the ground-engaging portion of the sole is substantially different from the length of the elongate member.

According to another broad aspect, the invention provides a cross-link for a track of a tracked vehicle. The track comprises a plurality of belts spaced apart to accommodate a plurality of wheels of the tracked vehicle, the belts having a ground-facing side for facing the ground. The cross-link comprises an elongate member for mounting to the belts to interconnect the belts. The elongate member has a belt-engaging face contacting the belts on the ground-facing side when the elongate member is mounted to the belts. The cross-link also comprises a sole mountable to the elongate member. The sole comprises a ground-engaging portion for engaging the ground. A ground contact area of the sole is substantially different from a projected area of the elongate member onto the ground.

According to another broad aspect, the invention provides a sole for a cross-link of a track of a tracked vehicle. The track comprises a plurality of belts spaced apart to accommodate a plurality of wheels of the tracked vehicle, the belts having a ground-facing side for facing the ground. The cross-link comprises an elongate member for mounting to the belts to interconnect the belts. The elongate member has a belt-engaging face contacting the belts on the ground-facing side when the elongate member is mounted to the belts. The sole is mountable to the elongate member and comprises a ground-engaging portion for engaging the ground. A ground contact area of the sole is substantially different from a projected area of the elongate member onto the ground.

These and other aspects of the invention will now become apparent to those of ordinary skill in the art upon review of the following description of embodiments of the invention in conjunction with the accompanying drawings.

### BRIEF DESCRIPTION OF THE DRAWINGS

A detailed description of embodiments of the invention is provided below, by way of example only, with reference to the accompanying drawings, in which:

FIGS. 1A and 1B show a side view and a front view of an example of a tracked vehicle comprising a pair of tracks each comprising a plurality of cross-links in accordance with an embodiment of the invention;

FIG. 2 shows perspective views of one of the tracks;

FIGS. 3, 4 and 5 show a front view, a top view and a side view of one of the tracks;

FIGS. 6 to 11 show perspective views, a side view, a top view, a front view and a bottom view of one of the cross-links;

FIGS. 12 to 14 show a perspective view, a front view, a top view, and a side view of an elongate member of the cross-link shown in FIGS. 6 to 11;

FIGS. 15 to 19 show a perspective view, a bottom view, a front view, a cross-sectional side view, and a side view of a sole of the cross-link shown in FIGS. 6 to 11;

FIG. 20 shows a front view of a sole in another embodiment of the invention; and

FIGS. 21 and 22 show a top view and a side view of a backing part of the cross-link shown in FIGS. 6 to 11.

It is to be expressly understood that the description and drawings are only for the purpose of illustrating certain embodiments of the invention and are an aid for understanding. They are not intended to be a definition of the limits of the invention.

### DETAILED DESCRIPTION OF EMBODIMENTS

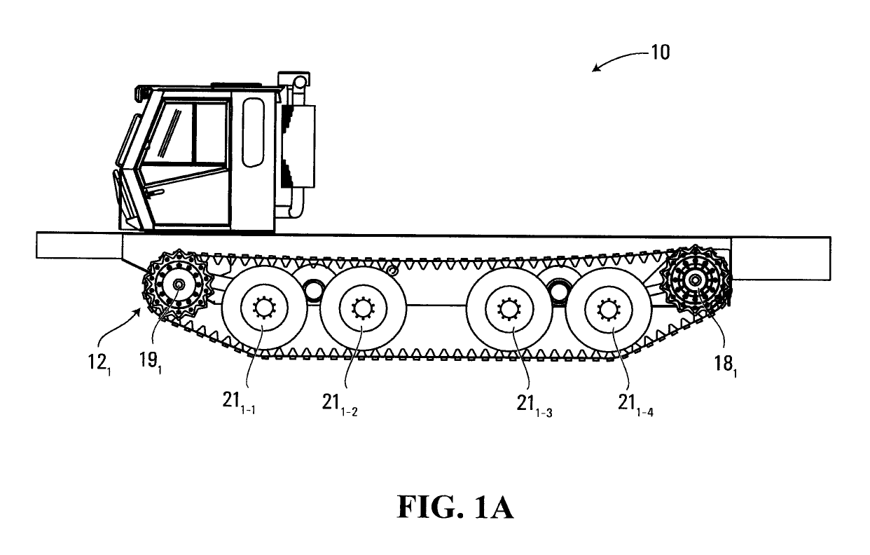

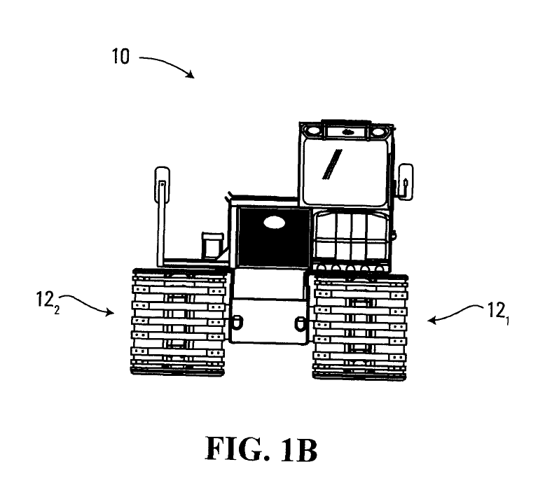

FIGS. 1A and 1B show a tracked vehicle 10 comprising a pair of endless tracks 12₁, 12₂ in accordance with an embodiment of the invention. In this embodiment, the tracked vehicle 10 is a tracked carrier vehicle designed to carry industrial or other equipment, such as, for example, a crane, a ladder, a lift, a drill, and/or any other apparatus to be carried, on various terrains, including rugged terrain (e.g., with mud, steep hills, swamps, rocks, mud, and/or snow). The tracked vehicle 10 can be used in various industrial, military and/or other applications.

In this embodiment, the tracked vehicle 10 comprises a prime mover (e.g., an internal combustion engine, an electric motor, etc.) in a driving relationship with a pair of drive wheels 18₁, 18₂ (in this case, sprockets) each driving a respective one of the tracks 12₁, 12₂ to propel the tracked vehicle 10 on a ground surface. As it is driven by the respective one of the drive wheels 18₁, 18₂, each of the tracks 12₁, 12₂ moves in an endless path around that drive wheel as well as a respective one of a pair of idler wheels 19₁, 19₂ (in this case, sprockets) and a respective one of two sets of support wheels 21₁₋₁-21₁₋₄, 21₂₋₁-21₂₋₄ of the tracked vehicle 10.

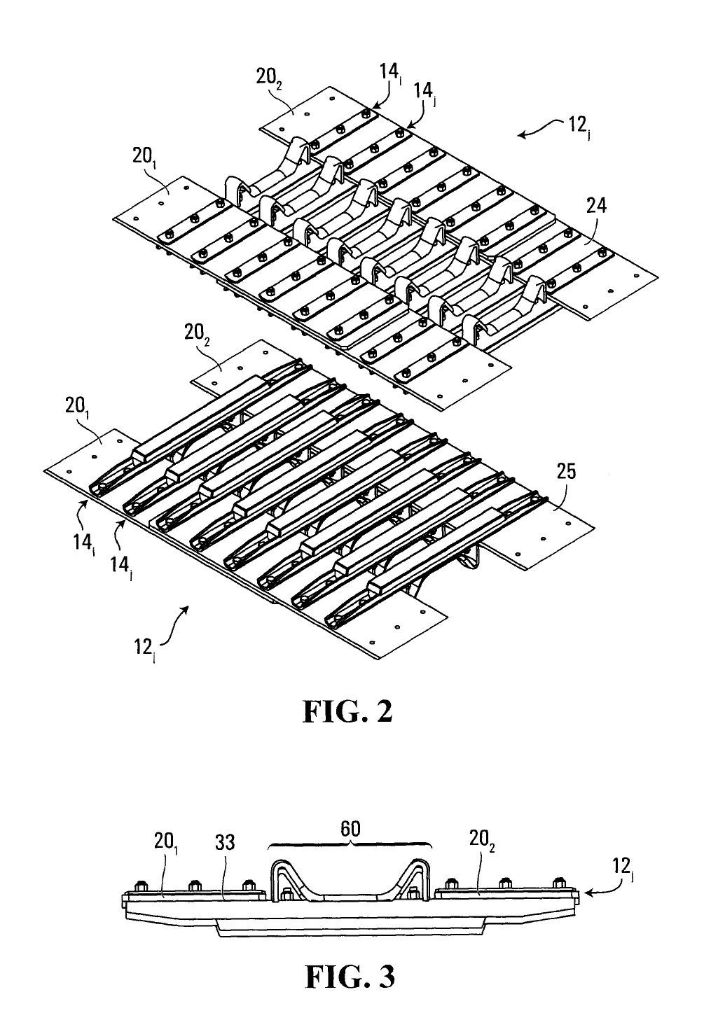

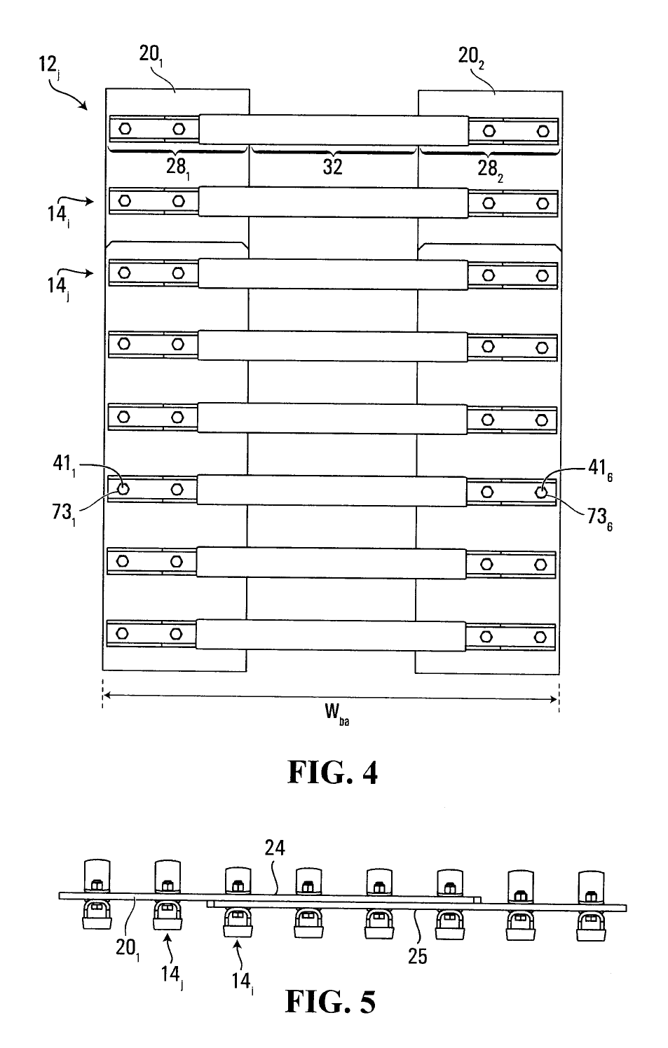

With additional reference to FIGS. 2 to 5, in this embodiment, each track 12ⱼ comprises a pair of belts 20₁, 20₂ spaced apart from one another to accommodate the drive wheel 18ⱼ₁, the idler wheel 19ⱼ and the support wheels 21ⱼ₋₁-21ⱼ₋₄ of the tracked vehicle 10. In addition, the track 12ⱼ comprises a series of cross-links 14₁-14_{N} distributed longitudinally along the track 12ⱼ and extending transversally to interconnect the belts 20₁, 20₂.

Each of the belts 20₁, 20₂ has an inner side 24 facing the wheels 18ⱼ, 19ⱼ, 21ⱼ₋₁-21ⱼ₋₄ and defining an inner area of the track 12ⱼ in which these wheels rotate. Each of the belts 20₁, 20₂ also has a ground-facing outer side 25 opposite the inner side 24 and facing the ground surface on which the tracked vehicle 10 travels. In this embodiment, each of the belts 20₁, 20₂ comprises a plurality of elastomeric (e.g., rubber) segments linked to one another form the belt. In other embodiments, the belts 20₁, 20₂ may have various other constructions. For example, in some embodiments, each of the belts 20₁, 20₂ may comprise a continuous length of elastomeric material (e.g., rubber) closed to form the belt, or a plurality of segments made of material other than elastomeric material (e.g., metallic sections) interconnected to form the belt. Also, while in this embodiment the track 12ⱼ comprises the two belts 20₁, 20₂, in other embodiments, the track 12ⱼ may comprise three or more such belts.

The cross-links 14₁-14_{N} interconnect the belts 20₁, 20₂ and interact with the wheels 18ⱼ, 19ⱼ, 21ⱼ₋₁-21ⱼ₋₄ as the track 12ⱼ moves in the endless path around these wheels. In particular, in this case, the cross-links 14₁-14_{N} interact with the drive wheel 18ⱼ to cause the track 12ⱼ to be driven by the drive wheel 18ⱼ. More specifically, in this embodiment, each cross-link 14ᵢ comprises lateral belt-engaging portions 28₁, 28₂, which contact the belts 20₁, 20₂ and via which it is secured to the belts 20₁, 20₂, and a central wheel-engaging portion 32, which contacts the wheels 18ⱼ, 19ⱼ, 21ⱼ₋₁-21ⱼ₋₄. As the drive wheel 18ⱼ rotates, the central wheel-engaging portions 32 of individual ones of the cross-links 14₁-14_{N} engage recesses in the drive wheel 18ⱼ which causes the track 12ⱼ to be driven in the endless path around the wheels 18ⱼ, 19ⱼ, 21ⱼ₋₁-21ⱼ₋₄. In addition, as the track 12ⱼ moves around the endless path, individual ones of the cross-links 14₁-14_{N} located on a bottom run of the track 12ⱼ engage the ground surface and thus contribute to traction of the tracked vehicle 10 on the ground surface.

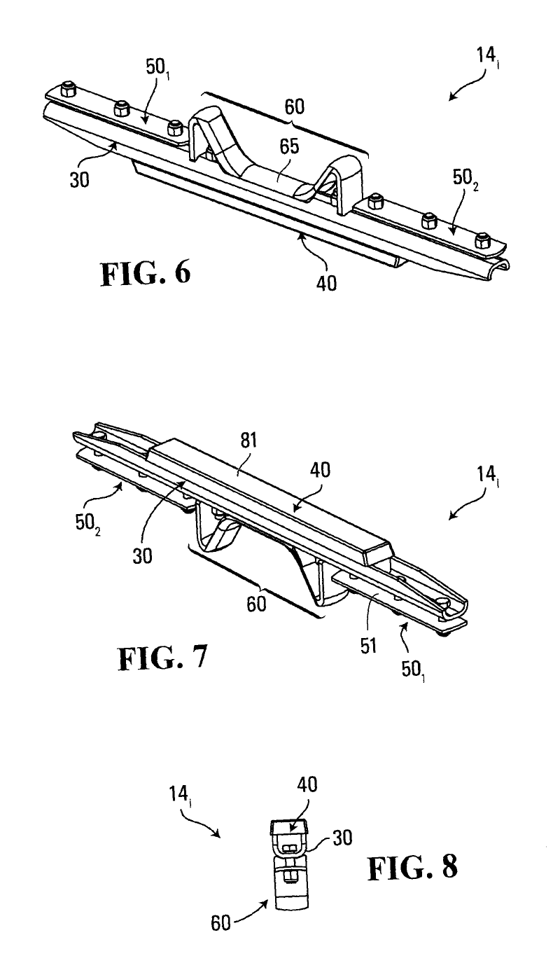

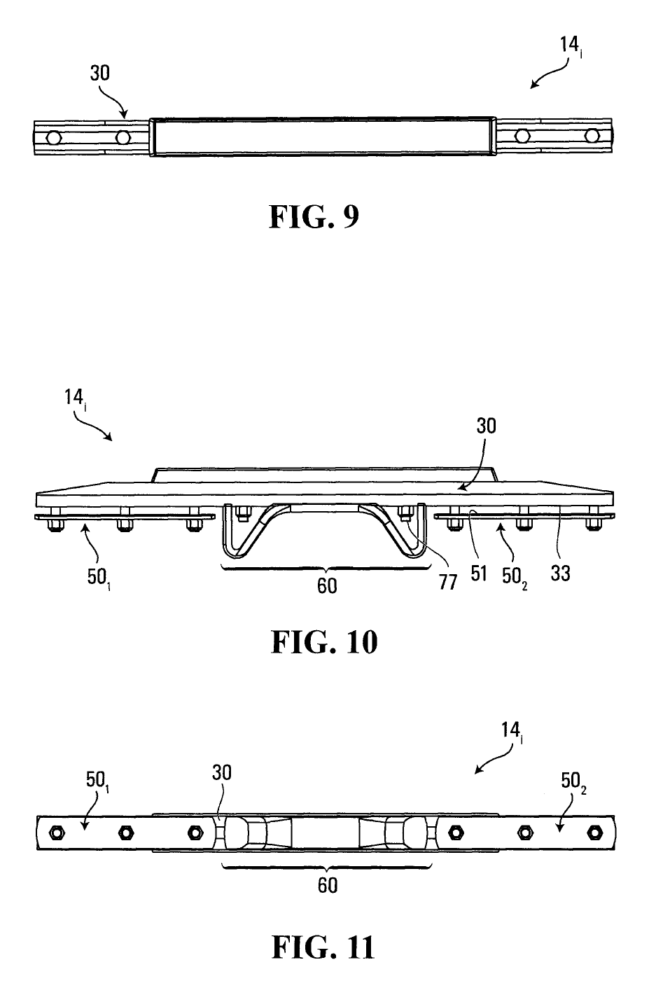

With additional reference to FIGS. 6 to 11, in this embodiment, each cross-link 14ᵢ comprises an elongate member 30, a sole 40, and a pair of backing parts 50₁, 50₂. As further discussed below, the sole 40 can be used when the tracked vehicle 10 is to travel on a hard surface (e.g., a paved surface) in order to minimize an impact of the cross-link 14ⁱ on that surface. For example, in some cases, the tracked vehicle 10 may be expected to mainly travel on a soft surface (e.g., mud, earth), but also be expected to sometimes have to move on a hard surface (e.g., crossing or otherwise moving on a paved road). In other cases, the tracked vehicle 10 may be expected to travel for longer distances and/or longer periods on a hard surface. In these and other cases, the sole 40 can be used as part of the cross-link 14ⁱ to help reduce the cross-link's potential to inflict damage to a hard surface. Conversely, in some cases, the sole 40 can be removed from or otherwise not used as part of the cross-link 14ᵢ (e.g., in situations where the tracked vehicle 10 is exclusively used on a soft surface or is used on a hard surface for which damage is not a concern).

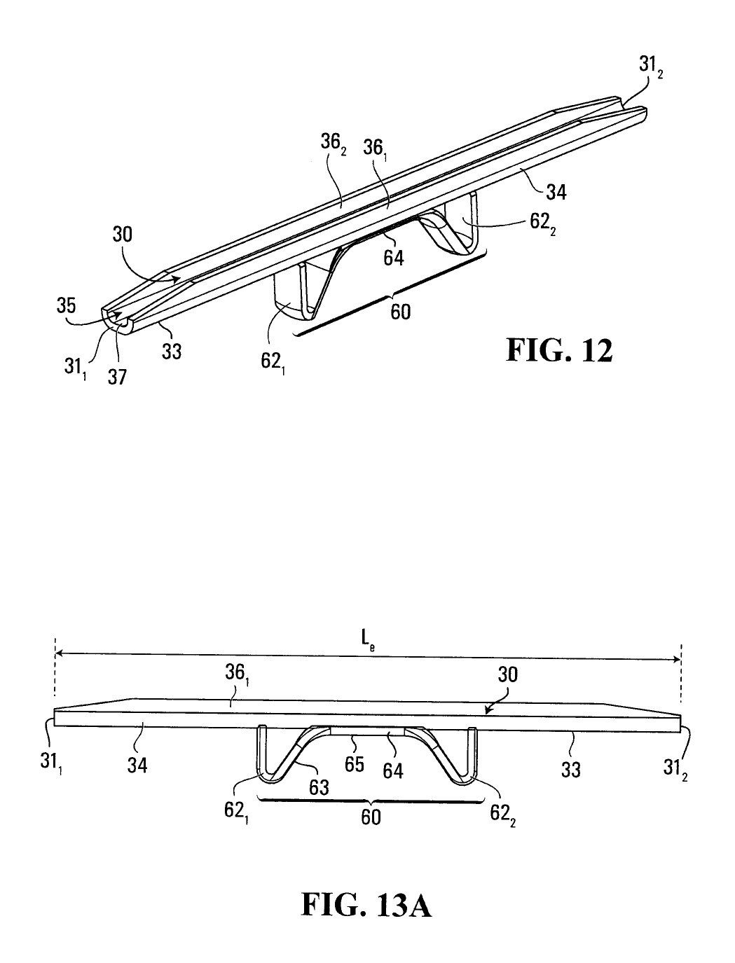

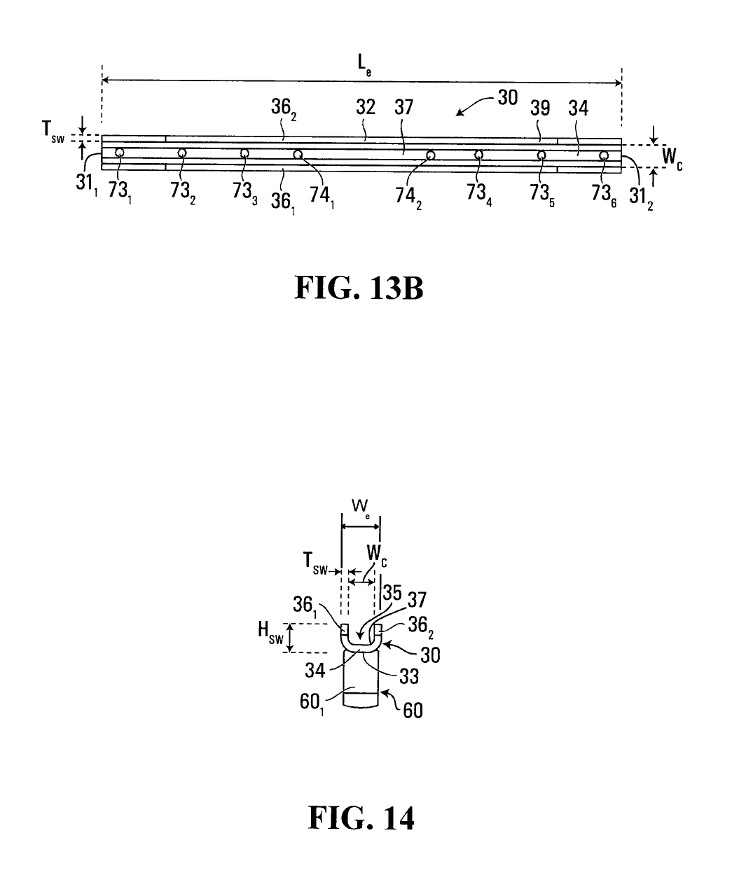

The elongate member 30 is configured to be mounted to the belts 20₁, 20₂ to interconnect the belts 20₁, 20₂. With additional reference to FIGS. 12 to 14, the elongate member 30 has a first longitudinal end 31₁ and a second longitudinal end 31₂ that define a length Lₑ of the elongate member 30. In this embodiment, the length Lₑ of the elongate member 30 generally corresponds to a width W_{ba} of a belt arrangement of the track 12ⱼ. The width W_{ba} of the belt arrangement of the track 12ⱼ is a widthwise distance between edges of the belts 20₁, 20₂ that are farthest from one another. In other embodiments, the length Lₑ of the elongate member 30 may be substantially different from (i.e., longer or shorter than) the width W_{ba} of the belt arrangement of the track 12ⱼ.

More particularly, in this embodiment, the elongate member 30 comprises a belt-engaging face 33 that is in contact with the ground-facing outer side 25 of the belts 20₁, 20₂, when the elongate member 30 is mounted to the belts 20₁, 20₂. In this case, the belt-engaging face 33 is generally flat, which may allow the weight of the tracked vehicle 10 to be distributed across the entire elongate member 30. In other cases, the belt-engaging face 33 may not be flat.

In this example, the elongate member 30 comprises a base portion 34 and a pair of sidewalls 36₁, 36₂. The sidewalls 36₁, 36₂ extend from the base portion 34 and lie opposite to one another on either side of the base portion 34 to define a channel 35. As further discussed later on, the channel 35 helps to receive and retain the sole 40 when the sole 40 is used as part of the cross-link 14ᵢ.

In this embodiment, the base portion 34 comprises a plurality of holes 73₁-73₆ passing through it to receive fasteners 41₁-41₆ to secure the elongate member 30 to the belts 20₁, 20₂. In this case, the holes 73₁-73₆ are divided equally between two sets. Each set is located in one of the lateral belt-engaging portions 28₁, 28₂ of the cross-link 14ⁱ, so that a first set with the holes 73₁-73₃ is located in the lateral belt-engaging portion 28₁ proximate the first longitudinal end 31₁, while a second set with the holes 73₄-73₆ is located in the lateral belt-engaging portion 28₂ proximate the second longitudinal end 31₂. The base portion 34 also comprises a plurality of holes 74₁, 74₂ extending therethrough to receive fasteners for securing the sole 40 to the elongate member 30 when the sole is used as part of the cross-link 14ⁱ. In other embodiments, the elongate member 30 may have a different number of holes and/or a different arrangement of holes.

The base portion 34 also comprises a sole-facing surface 37 that extends from the first longitudinal end 31₁ to the second longitudinal end 31₂ of the elongate member 30 and that is in contact with the sole 40 when the sole 40 is mounted in the channel 35. In this case, the sole-facing surface 37 is generally flat such that, as the sole 40 contacts the sole-facing surface 37 when mounted in the channel 35, there is a planar interface (i.e., contact points lying in a common plane) between the sole 40 and the bottom portion 34, which may allow a more uniform distribution of forces when the tracked vehicle 10 travels.

The sidewalls 36₁, 36₂ are configured to, on the one hand, enhance retention of the sole 40 when it is used as part of the cross-link 14ⁱ and, on the other hand, create a traction effect of the elongate member 30 on the ground surface on which the tracked vehicle 10 travels when the sole 40 is not used. Each of the sidewalls 36₁, 36₂ extends from the base portion 34 to a terminating edge 39.

More particularly, in this embodiment, the sidewalls 36₁, 36₂ are configured such that the channel 35 has a substantially constant width W_{c} from the first longitudinal end 31₁ to the second longitudinal end 31₂ of the elongate member 30 (while in practice there may be some slight variation in the width W_{c} of the channel 35 due to manufacturing of the elongate member 30, the width W_{c} is substantially constant in that it does not change from a macroscopic point of view). Specifically, in this case, the sidewalls 36₁, 36₂ have inner surfaces that are generally parallel to one another such that the width W_{c} of the channel 35 is substantially constant. Maintaining this substantially constant width W_{c} throughout the channel 35 along its entire length allows the elongate member 30 to be sturdier, facilitates its manufacturing, and provides a better interface with and retention of the sole 40 within the channel 35 when the sole 40 is used as part of the cross-link 14ⁱ.

Each of the sidewalls 36₁, 36₂ has a height H_{sw} (measured from the belt-engaging face 33 to its terminating edge 39) providing the channel 35 with an internal height that enhances retention of the sole 40 when the sole 40 is mounted therein. The height H_{sw} of each of the sidewalls 36₁, 36₂ also allows that sidewall to act as an aggressive traction element on the ground surface on which the tracked vehicle 10 travels, when the sole 40 is not used as part of the cross-link 14ⁱ. For example, in some embodiments, the height H_{sw} of each of the sidewalls 36₁, 36₂ may be of at least 30 mm, and in some cases 35 mm or more, to provide such desired enhanced retention of the sole 40 when it is used and aggressive traction effect when the sole 40 is not used. The height H may take on various other values in other embodiments.

In addition to the height H of the sidewalls 36₁, 36₂, when the sole 40 is not used as part of the cross-link 14ⁱ, the terminating edge 39 of each sidewall engages the ground surface on which the tracked vehicle 10 travels to form a region of localized pressure on the ground surface which enhances traction of the tracked vehicle 10.

Also, in this case, the height H_{sw} of the sidewalls 36₁, 36₂ is such that, when the sole 40 is not used as part of the cross-link 14ⁱ, any fasteners used to secure the elongate member 30 to the belts 20₁, 20₂ remain recessed within the channel 35, i.e., do not extend higher than the sidewalls 36₁, 36₂. Since contact between any part of a fastener that extended outside of the channel 35 and a hard ground surface (e.g., a paved road or sidewalk) could inflict damage on the ground surface, the height H_{sw} of the sidewalls 36₁, 36₂ helps reduce potential damage from the cross-link 14ⁱ on such a surface. Moreover, such contact between any part of a fastener outside of the channel 35 and a hard ground surface could also cause unnecessary wear to and decrease operational life of such fasteners, and thus the height H_{sw} of the sidewalls 36₁, 36₂ also helps to extend the operational life of the fasteners when the sole 40 is not used as part of the cross-link 14ⁱ.

In this embodiment, the sidewalls 36₁, 36₂ decrease in height proximate the first longitudinal end 31₁ and the second longitudinal end 31₂ of the elongate member 30. That is, each of the sidewalls 36₁, 36₂ has a first tapering end portion leading to the first longitudinal end 31₁ and a second tapering end portion leading to the second longitudinal end 31₂. These tapering end portions can facilitate turning of the cross-link 14ⁱ when the tracked vehicle 10 and the track 12ⱼ turn. Thus, in this and other embodiments where the sidewalls 36₁, 36₂ vary in height along their length, the height H_{sw} of each of the sidewalls 36₁, 36₂ can be taken as a maximum height of that sidewall along its length. Also, although in this embodiment both of the sidewalls 36₁, 36₂ have the same height H_{sw}, in some embodiments, the sidewalls 36₁, 36₂ may have different heights H_{sw}.

Each of the sidewalls 36₁, 36₂ also has a thickness T_{sw} (taken as its average thickness along its height H_{sw}) which provides sufficient strength and rigidity to that sidewall to allow it properly retain the sole 40 when the sole 40 is mounted in the channel 35 and to allow it to withstand forces exerted thereon while acting as a traction element when the sole 40 is not used as part of the cross-link 14ⁱ. For example, in some embodiments, the thickness T_{sw} of each of the sidewalls 36₁, 36₂ may be of at least 7.5 mm, and in some cases of at least 9.5 mm, to provide such desired enhanced retention of the sole 40 when it is used and aggressive traction effect when the sole 40 is not used. The thickness T_{sw} may take on various other values in other embodiments. Also, while in this embodiment both of the sidewalls 36₁, 36₂ have the same thickness T_{sw}, in other embodiments, the sidewalls 36₁, 36₂ may have different thicknesses T_{sw}.

The height H_{sw} and the thickness T_{sw} of each of the sidewalls 36₁, 36₂ can thus be selected to allow the sidewalls 36₁, 36₂ to both enhance retention of the sole 40 when it is used as part of the cross-link 14ⁱ and act as an aggressive traction element when the sole 40 is not used as part of the cross-link 14ᵢ. For example, in some embodiments, each of the sidewalls 36₁, 36₂ may have a height-to-thickness ratio H_{sw}/T_{sw} of at least 3.0, and in some cases 3.5 or more, to provide such desired enhanced retention of the sole 40 when it is used and aggressive traction effect when the sole 40 is not used, while maintaining sufficient strength and rigidity. The height-to-thickness ratio H_{sw}/T_{sw} may take on various other values in other embodiments.

In this embodiment, the elongate member 30, including the bottom portion 34 and the sidewalls 36₁, 36₂, is created by stamping, in this case bending, a single piece of material to form the elongate member 30. More particularly, in this embodiment, the single piece of material is a flat piece of metal (e.g., high-strength steel) which is bent into shape. Various bending techniques, involving plastic deformation of the single piece of material about a linear axis with little or no change in its surface area, are well-known and can be used for this process. These bending techniques can facilitate manufacturing of the elongate member 30 and allow proper formation of the sidewalls 36₁, 36₂ with a height-to-thickness H_{sw}/T_{sw} ratio as described above.

While in this embodiment the elongate member 30 comprises a single metallic piece that is formed and shaped through a stamping process, in other embodiments, the elongate member 30 may be produced using various other processes (e.g., casting) and/or various other materials (e.g., polymers, composites), and/or may comprise a plurality of distinct pieces that are connected to one another (e.g., by welding, fasteners, etc.) and that are made of the same material or different materials. For example, in some embodiments, the sidewalls 36₁, 36₂ and the bottom portion 34 may each be produced separately and then welded together to form the elongate member 30.

The elongate member 30 may be configured in various other ways in other embodiments. For example, in some embodiments, the base portion 34 and the sidewalls 36₁, 36₂ may have various other configurations such that the channel 35 may have various other configurations.

In this embodiment, the cross-link 14ⁱ comprises a wheel guide 60 to engage individual ones of the wheels 18ⱼ, 19ⱼ, 21ⱼ₋₁-21ⱼ₋₄ as the track 12ⱼ moves in the endless path around these wheels. More particularly, in this embodiment, the wheel guide 60 comprises a pair of guide projections 62₁, 62₂ that are spaced apart from one another and that extend from the belt-engaging face 33 and opposite the ground-facing outer side 25 (i.e., from the belt-engaging face 33 towards the inner area of the track 12ⱼ). The wheel guide 60 also comprises an intermediate portion 64 between and linking the guide projections 62₁, 62₂.

As the track 12ⱼ moves along its endless path, each of the wheels 18ⱼ, 19ⱼ, 21ⱼ₋₁-21ⱼ₋₄ passes through the wheel guide 60, and in particular, between the guide projections 62₁, 62₂ that are located on either side of these wheels. The guide projections 62₁, 62₂ can interact with the wheels 18ⱼ, 19ⱼ, 21ⱼ₋₁-21ⱼ₋₄ to keep the cross-link 14ⁱ centered by opposing any lateral movement outside of a space between these projections. As a result, the guide projections 62₁, 62₂ help to laterally guide the track 12ⱼ as it moves along its endless path.

In this embodiment, when viewed from a front or rear of the elongate member 30, each of the guide projections 62₁, 62₂ has a triangular shape, in this case resembling a right-angle triangle, with a wheel-facing face 63 that faces individual ones of the wheels 18ⱼ, 19ⱼ, 21ⱼ₋₁-21ⱼ₋₄ as the track 12ⱼ moves along its endless path. The wheel-facing face 63 of each of the guide projections 62₁, 62₂ lies at an obtuse angle relative to the belt-engaging face 33, which can help center the elongate member 30 (and therefore the cross-link 14ⁱ) as it comes into contact with any of the wheels 18ⱼ, 19ⱼ, 21ⱼ₋₁-21ⱼ₋₄. More specifically, any lateral motion of the elongate member 30 towards outside of the space between the guide projections 62₁, 62₂ will be counteracted when the wheel-facing face 63 of one of the guide projections 62₁, 62₂ comes into contact with one of the wheels 18ⱼ, 19ⱼ, 21ⱼ₋₁-21ⱼ₋₄, thus guiding the elongate member 30 back towards a center region of the space between the guide projections 62₁, 62₂.

While in this embodiment the guide projections 62₁, 62₂ are configured as right-angled triangles, in other embodiments, the guide projections 62₁, 62₂ may have various other shapes. For example, in some embodiments, the guide projections 62₁, 62₂ may be configured as non-right-angled triangles (e.g., isosceles or equilateral triangles). As another example, in some embodiments, the wheel-facing face 63 may define an arc that approximates a profile of the wheels 18ⱼ, 19ⱼ, 21ⱼ₋₁-21ⱼ₋₄.

The intermediate portion 64 of the wheel guide 60 has a bearing surface 65 which contacts individual ones of the wheels 18ⱼ, 19ⱼ, 21ⱼ₋₁-21ⱼ₋₄ as the track 12ⱼ moves around these wheels. In this case, the bearing surface 65 is curved (e.g., convex in this example) in the widthwise direction of the cross-link 14ᵢ. The bearing surface 65 may have a curvature that complements a curvature of a surface of the drive wheel 18ⱼ which engages the bearing surface 65 in use. The intermediate portion 64 also has a member-engaging surface (not shown) opposite the bearing surface 65 and engaging the elongate member 30. In this case, the member-engaging surface is also curved. The bearing surface 65 and/or the member-engaging surface of the intermediate portion 64 may be flat, partly flat and partly curved, or shaped in various other ways in other cases.

In this embodiment, the wheel guide 60, including the guide projections 62₁, 62₂ and the intermediate portion 64, is a one-piece component which has been formed into shape. More particularly, in this case, the wheel guide 60 is a single piece of metal (e.g., high-strength steel) cast into shape. In other cases, the wheel guide 60 may be produced using various other processes (e.g., bending) and/or various other materials (e.g., polymers, composites), and/or may comprise a plurality of distinct pieces that are connected to one another (e.g., by welding, fasteners, etc.) and that are made of the same material or different materials. For example, in some embodiments, the guide projections 62₁, 62₂ and the intermediate portion 64 may each be produced separately and then welded together to form the wheel guide 60.

Also, in this embodiment, the wheel guide 60 is secured to the elongate member 30 by welding. In this case, the guide projections 62₁, 62₂ and the intermediate portion 64 are individually welded to the belt-engaging face 33. The wheel guide 60 may be secured to the elongate member 30 in various other ways in other embodiments. For example, in some embodiments, the guide projections 62₁, 62₂ and/or the intermediate portion 64 may be secured to the elongate member 30 via nut and bolt fasteners. As another example, in some embodiments, the guide projections 62₁, 62₂ and/or the intermediate portion 64 may be integrally formed with the elongate member 30 (e.g., by casting).

The wheel guide 60 may be configured in various other ways in other embodiments. For example, in some embodiments, the intermediate portion 64 may be omitted, in which case the guide projections 62₁, 62₂ are individually secured to (e.g., by welding or fasteners) or integrally formed with the elongated member 30 and spaced apart from one another by a portion of the elongated member 30.

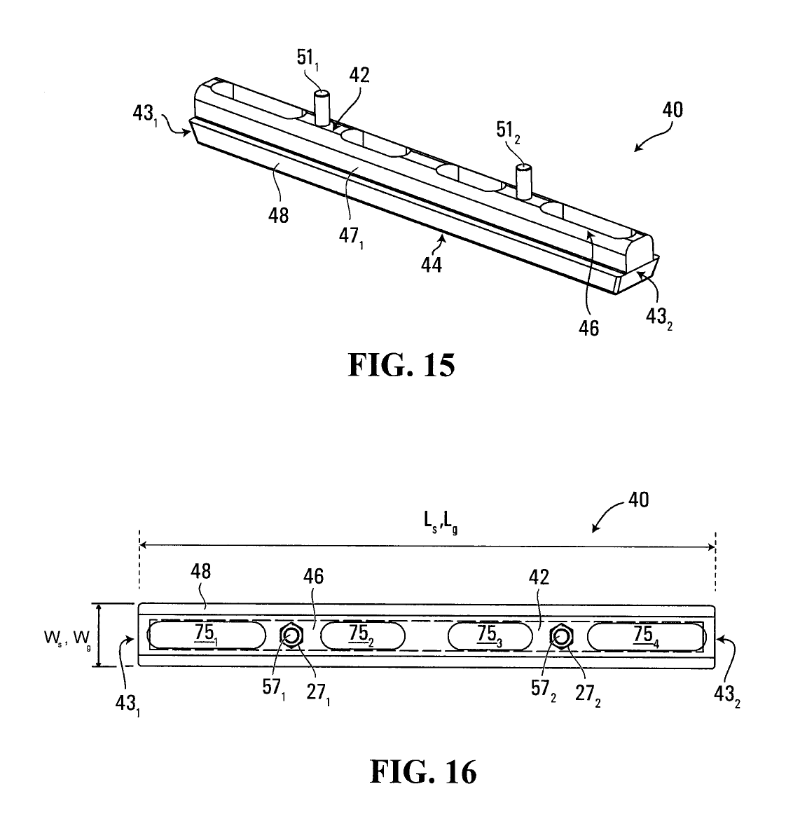

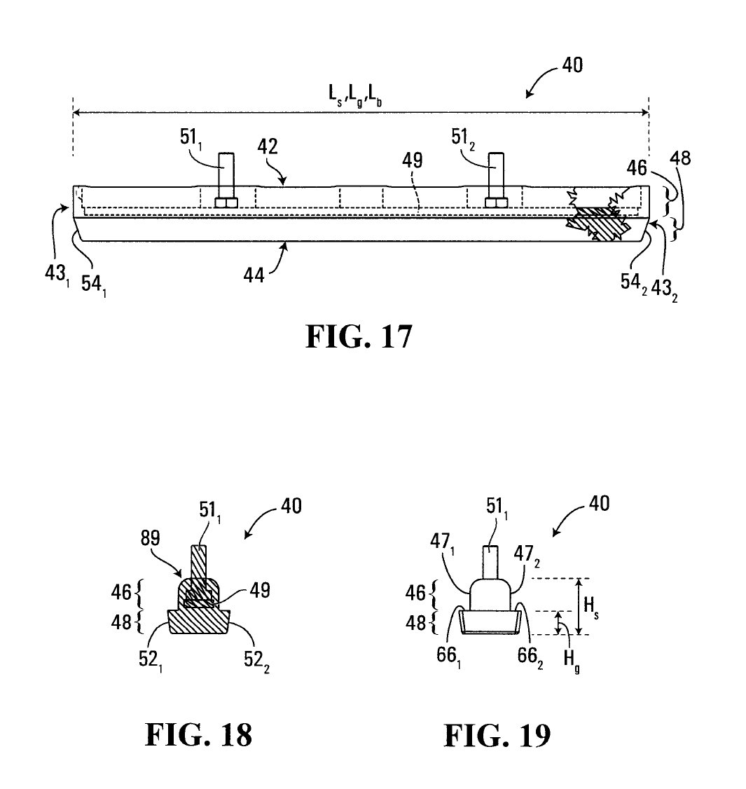

With additional reference to FIGS. 15 to 19, the sole 40 can be mounted to the elongate member 30 when the tracked vehicle 10 is to travel on a hard surface (e.g., a paved surface) in order to minimize an impact of the cross-link 14ᵢ on that surface. The sole 40 comprises an inner side 42 for facing the elongate member 30 and an outer side 44 opposite the inner side 42 for engaging the ground on which the tracked vehicle 10 moves.

The sole 40 comprises a base portion 46 mountable to the elongate member 30 and a ground-engaging portion 48 for engaging the ground on which the tracked vehicle 10 travels.

In this embodiment, the base portion 46 of the sole 40 is mountable within the channel 35 of the elongate member 30. More particularly, in this case, the base portion 46 of the sole has a periphery generally complementary to that of the channel 35 of the elongate member 30. The base portion 46 of the sole 40 comprises a pair of sidewall-engaging surfaces 47₁, 47₂ for engaging the sidewalls 36₁, 36₂ of the elongate member 30 when the sole 40 is mounted in the channel 35. Thus, in this case, the sidewall-engaging surfaces 47₁, 47₂ are generally parallel to one another and separated by a distance corresponding to the width W_{c} of the channel 35 to allow the base portion 46 of the sole 40 to fit within the channel 35. When the base portion 46 is mounted within the channel 35, the sidewall-engaging surfaces 47₁, 47₂ contact the sidewalls 36₁, 36₂ of the elongate member 30, which helps retains the sole 40 in the channel 35 when the cross-link 14ᵢ is subjected to forces as the tracked vehicle 10 moves on the ground surface.

Also, in this embodiment, the base portion 46 of the sole 40 comprises a plurality of openings 75₁-75₄ extending inwardly from a bottom surface of the sole 40. Some of these openings may accommodate parts (e.g., heads) of some of the fasteners 73₁-73₆ fastening the elongate member 30 to the belts 20₁, 20₂, such as the openings 75₁, 75₄ in this example which receive heads of the fasteners 73₃, 73₄.

The base portion 46 of the sole 40 may be configured in various other ways in other embodiments.

The ground-engaging portion 48 of the sole 40 has a ground contact surface 81 which is in contact with the ground on which the tracked vehicle 10 moves. In this embodiment, the ground contact surface 81 is generally flat. In particular, in this case, the ground contact surface 81 lacks any space in which a rock or other hard object on the ground could become trapped when it contacts the ground surface. In other embodiments, the ground contact surface 81 may be curved, may define a tread pattern which can assist in improving traction of the tracked vehicle 10 and/or channeling water or other liquid away under wet or adverse weather conditions, and/or may be configured in various other ways.

In this embodiment, the ground-engaging portion 48 comprises polymeric material that contacts the ground surface on which the tracked vehicle 10 moves. Various polymeric compounds may be used and, in some cases, different polymeric compounds may be present in different areas of the ground-engaging portion 48. In some examples, the polymeric material of the ground-engaging portion 48 may comprise rigid polymeric material (e.g., polyurethane). In other examples, the polymeric material of the ground-engaging portion 48 may comprise elastomeric material (e.g., rubber and/or another elastomer, such as polyurethane elastomer).

More particularly, in this embodiment, the polymeric material of the ground-engaging portion 48 comprises polyurethane. The polyurethane may contribute to increasing a useful life of the sole 40.

When the ground surface is hard (e.g., a paved road), the polymeric material of the ground-engaging portion 48 helps minimize effects of the cross-link 14ᵢ as it comes into repeated contact with the hard ground surface. The polymeric material of the ground-engaging portion 48 may also help providing traction for the tracked vehicle 10 to travel along such a surface. For example, in some cases, the polymeric material of the ground-engaging portion 48 may “grip” the ground surface on which the tracked vehicle 10 travels.

In this embodiment, the ground-engaging portion 48 of the sole 40 is wider than the base portion 46 of the sole 40. More particularly, in this embodiment, the ground-engaging portion 48 comprises shoulders 66₁, 66₂ which overhang the base portion 46, i.e., extend beyond the base portion 46 in the widthwise direction of the sole 40. When the sole 40 is mounted to the elongate member 30, the shoulders 66₁, 66₂ of the ground-engaging portion 48 overlie, and in this case rest against, the terminating edges 39 of the sidewalls 36₁, 36₂ of the elongate member 30. In this case, the shoulders 66₁, 66₂ of the ground-engaging portion 48 extend beyond the sidewalls 36₁, 36₂ of the elongate member 30 in the widthwise direction of the cross-link 14ⱼ. In other embodiments, the ground-engaging portion 48 of the sole 40 may not be wider than (i.e., it may be as wide as or narrower than) the base portion 46 of the sole 40.

Also, in this embodiment, the ground-engaging portion 48 of the sole 40 tapers along the height direction of the sole 40. That is, a longitudinal cross-sectional area of the ground-engaging portion 48 decreases along the height direction of the sole 40. Specifically, in this case, the ground-engaging portion 48 has front and rear surfaces 52₁, 52₂ that converge along the height direction of the sole 40, and lateral surfaces 54₁, 54₂ that also converge along the height direction of the sole 40. This tapered shape of the ground-engaging portion 48, in particular the convergent lateral surfaces 54₁, 54₂, may facilitate turning of the tracked vehicle 10 on the ground.

The ground-engaging portion 48 of the sole 40 may be configured in various other ways in other embodiments.

The base portion 46 and the ground-engaging portion 48 of the sole 40 are integral with one another in this embodiment. More particularly, in this embodiment, the base portion 46 and the ground-engaging portion 48 of the sole 40 constitute a single polymeric component molded into shape. In this case, the base portion 46 of the sole 40 is made of the same polymeric material (in this case, polyurethane) as the ground-engaging portion 48. In other cases, the base portion 46 and the ground-engaging portion 48 may be made of different polymeric material. In other embodiments, the base portion 46 and the ground-engaging portion 48 of the sole 40 may be components distinct from but connected to one another and/or may be made of the same material or different materials and/or using various other processes. For example, in some embodiments, the base portion 46 may be made of rigid material, such as a ultra-high molecular weight (UHMW) plastic or other rigid plastic or a metal, while the ground-engaging portion 48 may be made of polymeric material and be secured to the base portion 46 through one or more fasteners (e.g., screws or nuts/bolts) or some bonding technique (e.g., glue or epoxy).

When the sole 40 is used as part of the cross-link 14ᵢ, it is mounted to the elongate member 30 via a fastening mechanism 89. In this embodiment, the fastening mechanism 89 comprises a plurality of fasteners 51₁, 51₂ that extend from the inner side 42 of the sole 40.

In this case, the fasteners 51₁, 51₂ are integrated with the sole 40. More particularly, in this case, the sole 40 comprises a frame member 49 which acts as an armature on which the polymeric material of the sole 40 is supported. Specifically, in this embodiment, the polymeric material of the base portion 46 and the ground-engaging portion 48 of the sole 40 is molded around the frame member 49 and the fasteners 51₁, 51₂. In addition to facilitating manufacturing of the sole 40, this integration of the frame member 49 and the fasteners 51₁, 51₂ with a remainder of the sole 40 help simplify and speed up mounting and dismounting of the sole 40 to and from the elongate member 30.

The frame member 49, which may be made of any suitable rigid material (e.g., steel), supports the fasteners 51₁, 51₂. For example, the fasteners 51₁, 51₂ may be attached to the frame member 49 by screwing one of their ends into the frame member 49 or by welding one of their ends to the frame member 49. Alternatively, the fasteners 51₁, 51₂ may be integrally formed with the frame member 49.

In this case, the fasteners 51₁, 51₂ are arranged such that, when the sole 40 is mounted to the elongate member 30, each of them is positioned in a space 77 defined by one of the guide projections 62₁, 62₂ under that guide projection. The fasteners 51₁, 51₂ may are arranged in other manners in other cases.

In this embodiment, the outer side 44 of the sole 40 lacks holes through which the fasteners 51₁, 51₂ are exposed when the sole 40 is mounted to the elongate member 30. This lack of holes on the outer side 44 of the sole 40 prevents rocks and other objects from being trapped in the outer side 44 of the sole 40, which could otherwise contribute to damaging a hard ground surface (e.g., a paved road) on which the tracked vehicle 10 travels under the vehicle's weight.

More specifically, in this case, the sole 40 comprises a plurality of blind holes 27₁, 27₂ which extend from its inner side 42 without reaching its outer side 44, and in which are received the fasteners 51₁, 51₂. As a result, when the sole 40 is mounted to the elongate member 30, the outer side 44 of the sole 40 lacks holes through which the fasteners 51₁, 51₂ would otherwise be exposed. This seamless nature of the outer side 44 prevents rocks and other small objects from becoming trapped within such holes and also protects the fasteners 51₁, 51₂ from damage from such debris, which may extend their operational life.

While in this embodiment the fasteners 51₁, 51₂ are integrated with the sole 40, in other embodiments, separate fasteners may be used to mount the sole 40 to the elongate member 30 (e.g., by screwing them into the base portion 46 of the sole 40 from its inner side 24).

Also, although the fastening mechanism 89 comprises two threaded fasteners 51₁, 51₂ in this embodiment, the fastening mechanism 89 may comprise more or less threaded fasteners or may not comprise any threaded fasteners but some other type of fastening elements in other embodiments.

The sole 40 has a first longitudinal end 43₁ and a second longitudinal end 43₂ that define a length Lₛ of the sole 40. In this case, the longitudinal ends 43₁, 43₂ of the sole 40 are also those of the base portion 46 of the sole 40 and those of the ground-engaging portion 48 of the sole 40 such that a length L_{b} of the base portion 46, a length L_{g} of the ground-engaging portion 48, and the length Lₛ of the sole 40 are all the same.

In this embodiment, the length Lₛ of the sole 40 is substantially different from the length Lₑ of the elongate member 30. More particularly, in this embodiment, the length Lₛ of the sole 40 is substantially shorter than the length Lₑ of the elongate member 30. In this example, a ratio Lₛ/Lₑ of the length Lₛ of the sole 40 to the length Lₑ of the elongate member 30 is about 0.5. The ratio Lₛ/Lₑ may take on various other values in other examples. For instance, in some examples, the ratio Lₛ/Lₑ may be no more than 0.9, in some cases no more than 0.8, in some cases no more than 0.7, in some cases no more than 0.6, in some cases no more than 0.5, in some cases no more than 0.4, and in some cases no more than 0.3.

By having the ground-engaging portion 48 of the sole 40 substantially shorter than the elongate member 30, more pressure may be applied on the ground by the ground-engaging portion 48 (than if the length L_{g} of the ground-engaging portion 48 was the same as the length Lₑ of the elongate member 30). In turn, this may induce greater penetration of the sole 40 into a soft ground surface, creating an enhanced traction effect when the tracked vehicle 10 travels on such a surface. For example, in some embodiments, on a given ground surface, a penetration depth of the sole 40 into the ground may be greater than a penetration depth of the elongate member 30, when the sole 40 is not used as part of the cross-link 14ⁱ, into the ground.

More generally, in this embodiment, a ground contact area Aₛ of the sole 40 is substantially different from a projected area Aₑ of the elongate member 30 onto the ground. The ground contact area Aₛ of the sole 40 is the area (e.g., in mm² or other surface units) of the ground contact surface 81 of the sole 40. The projected area Aₑ of the elongate member 30 onto the ground is the area (e.g., in mm² or other surface units) obtained by projecting the elongate member's shape onto an imaginary plane parallel to the ground, when the sole 40 is not used as part of the cross-link 14ᵢ. For example, in this case, the projected area Aₑ of the elongate member 30 onto the ground is equal to the length Lₑ of the elongate member 30 multiplied by a width Wₑ of the elongate member 30.

In this embodiment, the ground contact area Aₛ of the sole 40 is substantially less than the projected area Aₑ of the elongate member 30 onto the ground. For instance, in some examples, a ratio Aₛ/Aₑ of the ground contact area Aₛ of the sole 40 to the projected area Aₑ of the elongate member 30 onto the ground may be no more than 0.9, in some cases no more than 0.8, and in some cases no more than 0.7. The ratio Aₛ/Aₑ may have various other values in other embodiments.

The enhanced traction effect may be increased with a height H_{g} of the ground-engaging portion 48 of the sole 40. For instance, in some examples, the height H_{g} of the ground-engaging portion 48 of the sole 40 may be at least 20 mm, in some cases at least 25 mm, in some cases at least 30 mm, and in some cases at least 35 mm. Alternatively or additionally, in some examples, the height H_{g} of the ground-engaging portion 48 of the sole 40 may be at least 30%, in some cases at least 35%, in some cases at least 40%, and in some cases at least 45% of a height Hₛ of the sole 40 (excluding the fasteners 51₁, 51₂).

The sole 40 may be configured in various other ways in other embodiments.

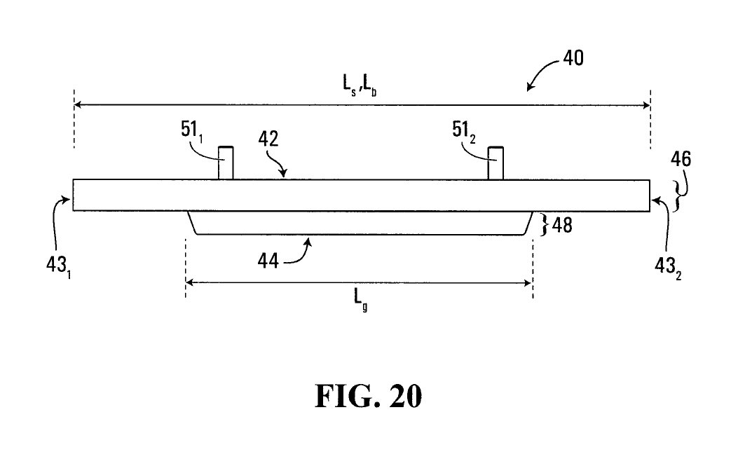

For example, although in this embodiment the length L_{b} of the base portion 46 of the sole 40 and the length L_{g} of the ground-engaging portion 48 of the sole 40 are the same and correspond to the length Lₛ of the sole 40, in some embodiments, the length L_{b} of the base portion 46 and the length L_{g} of the ground-engaging portion 48 may be substantially different. For instance, in some embodiments, as shown in FIG. 20, the length L_{g} of the ground-engaging portion 48 may be substantially shorter than the length L_{b} of the base portion 46, which corresponds to the length Lₛ of the sole 40. In such cases, a ratio L_{g}/Lₑ of the length L_{g} of the ground-engaging portion 48 to the length Lₑ of the elongate member 30 may be as discussed above in respect of the ratio Lₛ/Lₑ of the length Lₛ of the sole 40 to the length Lₑ of the elongate member 30. For example, the ratio L_{g}/Lₑ may be no more than 0.8, in some cases no more than 0.7, in some cases no more than 0.6, in some cases no more than 0.5, in some cases no more than 0.4, and in some cases no more than 0.3. Also, in such cases, the length L_{b} of the base portion 46 may generally correspond to the length Lₑ of the elongate member 30 or may be substantially different from (i.e., shorter or longer than) the length Lₑ of the elongate member 30 (e.g., the length L_{b} of the base portion 46 may correspond to the length Lₑ of the elongate member 30 such that the base portion 46 occupies the entire channel 35 of the elongate member 30, while the length L_{g} of the ground-engaging portion 48 is 40%, 50% or 60% of the length Lₑ of the elongate member 30).

As another example, although in this embodiment the length Lₛ of the sole 40 is substantially shorter than the length Lₑ of the elongate member 30, in other embodiments, the length Lₛ of the sole 40 may be substantially longer than the length Lₑ of the elongate member 30. This may be useful, for instance, in situations where it is desired to reduce the pressure applied on the ground by the cross-link 14ⁱ. For instance, in some examples, a ratio Lₛ/Lₑ of the length Lₛ of the sole 40 to the length Lₑ of the elongate member 30 may be at least 1.1, in some cases at least 1.2, in some cases at least 1.3, and in some cases at least 1.4.

As yet another example, although in this embodiment the ground contact area Aₛ of the sole 40 is substantially less than the projected area Aₑ of the elongate member 30 onto the ground, in other embodiments, the ground contact area Aₛ of the sole 40 may be substantially greater than the projected area Aₑ of the elongate member 30 onto the ground. This may be useful, for instance, in situations where it is desired to reduce the pressure applied on the ground by the cross-link 14ⁱ. For instance, in some examples, the ratio Aₛ/Aₑ of the ground contact area Aₛ of the sole 40 to the projected area Aₑ of the elongate member 30 onto the ground may be at least 1.1, in some cases at least 1.2, and in some cases at least 1.3.

As yet another example, although in this embodiment the ground contact area Aₛ of the sole 40 is substantially different from the projected area Aₑ of the elongate member 30 onto the ground primarily due to the difference between the length L_{g} of the ground-engaging portion 48 of the sole 40 and the length Lₑ of the elongate member 30, in other embodiments, the substantial difference between the ground contact area Aₛ of the sole 40 and the projected area Aₑ of the elongate member 30 onto the ground may be primarily due to a difference between a width W_{g} of the ground-engaging portion 48 of the sole 40 and the width Wₑ of the elongate member 30. For instance, in some examples, a ratio W_{g}/Wₑ may be no more than 0.9, in some cases no more than 0.8, in some cases no more than 0.7, in some cases no more than 0.6, in some cases no more than 0.5, in some cases no more than 0.4, and in some cases no more than 0.3.

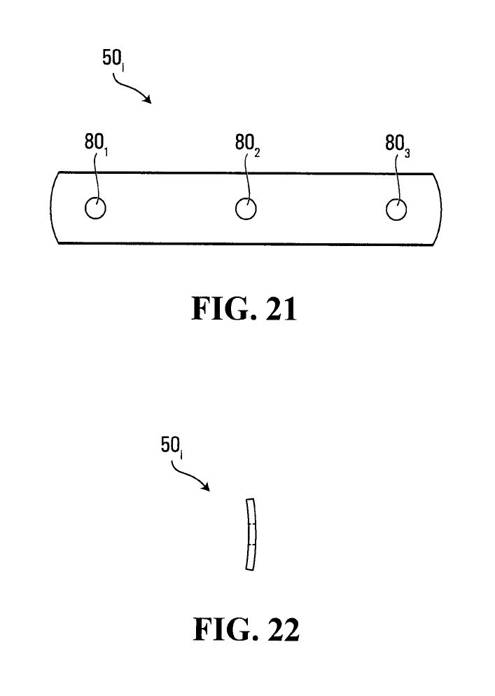

With additional reference to FIGS. 21 and 22, the backing parts 50₁, 50₂ are configured to be mounted to the belts 20₁, 20₂ to assist the elongate member 30 in interconnecting the belts 20₁, 20₂. Each of the backing parts 50₁, 50₂ has a belt-engaging face 51 that contacts a respective one of the belts 20₁, 20₂ on its inner side 24 when the backing part is mounted to that belt. Thus, when the cross-link 14ⱼ is mounted to the belts 20₁, 20₂, the belts 20₁, 20₂ are sandwiched between the belt-engaging face 33 of the elongate member 30 and the belt-engaging face 51 of each of backing parts 50₁, 50₂.

In this embodiment, the backing parts 50₁, 50₂ are metallic plates that may be formed from any suitably rigid metallic material (e.g., steel). Each of the backing parts 50₁, 50₂ is pierced with a plurality of holes 80₁-80₃ to receive the fasteners 41₁-41₆ to interconnect the elongate member 30 to the belts 20₁, 20₂.

The belts 20₁, 20₂ lie between the belt-engaging face 33 of the elongate member 30 on one side (i.e., the ground-facing side 25) and the belt-engaging face 51 of one of the backing parts 50₁, 50₂ on the other side (i.e., the inner side 24). Holes in the belts 20₁, 20₂ allow alignment of the holes 73₁-73₆ of the elongate member 30 and the holes 80₁-80₃ of the backing parts 50₁, 50₂ that sandwich the belts. When suitably aligned, a fastener (e.g., 41₁) inserted through one of the holes 73₁-73₆ of the elongate member 30 emerges through the belt-engaging face 33, passes through the corresponding hole in the belt (20₁ or 20₂), and then emerges through the corresponding hole (e.g., 80₁) in the belt-engaging face 51.

When the holes 73₁-73₆ of the elongate member 30 are so aligned with the holes in the belts 20₁, 20₂, the elongate member 30 lies transversely across the ground-facing side 25 of each of the belts. Each of the backing parts 50₁, 50₂ lies transversely across the inner side 24 of one of the belts 20₁, 20₂. In this configuration, the elongate member 30 and the backing parts 50₁, 50₂ are appropriately aligned with the belts 20₁, 20₂. The fasteners 41₁-41₆ are used to attach these components together and thus form the cross-link 14ⁱ with the sole 40 mounted thereon.

It will thus be appreciated that this ability to mount and dismount the sole 40 from elongate member 30 allows the tracked vehicle 10 to traverse a wide variety of ground surfaces with improved traction while minimizing impact on hard surfaces.

Although various embodiments and examples have been presented, this was for the purpose of describing, but not limiting, the invention. Various modifications and enhancements will become apparent to those of ordinary skill in the art and are within the scope of the invention, which is defined by the appended claims.

1. A cross-link for a track of a tracked vehicle, the track comprising a plurality of belts spaced apart to accommodate a plurality of wheels of the tracked vehicle, the belts having a ground-facing side for facing the ground, the cross-link comprising:
an elongate member for mounting to the belts to interconnect the belts, the elongate member having a belt-engaging face contacting the belts on the ground-facing side when the elongate member is mounted to the belts, the elongate member having a length; and
a sole mountable to the elongate member, the sole comprising a ground-engaging portion for engaging the ground, the ground-engaging portion of the sole having a length, the length of the ground-engaging portion of the sole being substantially different from the length of the elongate member.

2. The cross-link claimed in claim 1, wherein the length of the ground-engaging portion of the sole is substantially shorter than the length of the elongate member.

3. The cross-link claimed in claim 2, wherein a ratio of the length of the ground-engaging portion of the sole to the length of the elongate member is no more than 0.8.

4. (canceled)

5. (canceled)

6. The cross-link claimed in claim 1, wherein the sole has a length, the length of the sole being substantially different from the length of the elongate member.

7. The cross-link claimed in claim 6, wherein the length of the sole is substantially shorter than the length of the elongate member.

8. The cross-link claimed in claim 7, wherein a ratio of the length of the sole to the length of the elongate member is no more than 0.8.

9-11. (canceled)

12. The cross-link claimed in claim 1, wherein the ground-engaging portion of the sole comprises polymeric material that contacts the ground when the tracked vehicle moves.

13. The cross-link claimed in claim 12, wherein the polymeric material comprises polyurethane.

14. The cross-link claimed in claim 12, wherein the polymeric material comprises elastomeric material.

15. The cross-link claimed in claim 1, wherein the elongate member comprises a bottom portion and a pair of sidewalls extending from the bottom portion, the bottom portion and the sidewalls defining a channel, the sole comprising a base portion located in the channel when the sole is mounted to the elongate member.

16-18. (canceled)

19. The cross-link claimed in claim 15, wherein each of the sidewalls has a height such that any fastener used to secure the elongate member to the belts does not extend higher than the sidewalls.

20. The cross-link claimed in claim 15, wherein the sidewalls are stamped sidewalls.

21. The cross-link claimed in claim 15, wherein the base portion of the sole comprises a pair of sidewall-engaging surfaces for engaging the sidewalls when the sole is located in the channel, the sidewall-engaging surfaces being generally parallel to one another.

22. The cross-link claimed in claim 15, wherein the sidewalls have terminating edges, the ground-engaging portion of the sole overlying the terminating edges when the sole is mounted to the elongate member.

23. The cross-link claimed in claim 15, wherein the ground-engaging portion of the sole is wider than the base portion of the sole.

24. The cross-link claimed in claim 1, comprising a wheel guide comprising a pair of guide projections spaced apart from one another, the guide projections extending from the belt-engaging face and opposite the ground-facing side, the wheel guide engaging the wheels of the tracked vehicle as the tracked vehicle moves such that, when the wheel guide engages a given one of the wheels, the given one of the wheels is received between the guide projections.

25. The cross-link claimed in claim 24, wherein the wheel guide is welded to the elongate member.

26. The cross-link claimed in claim 24, wherein the wheel guide comprises an intermediate portion between and linking the guide projections.

27. The cross-link claimed in claim 26, wherein the intermediate portion of the wheel guide has a bearing surface which contacts the wheels of the tracked vehicle as the tracked vehicle moves, the bearing surface being curved in a widthwise direction of the cross-link.

28-30. (canceled)

31. The cross-link claimed in claim 1, wherein the ground-engaging portion of the sole has a top surface lacking any space in which a rock could become trapped when the ground-engaging portion of the sole contacts the ground.

32. The cross-link claimed in claim 1, wherein the ground-engaging portion of the sole tapers along a height direction of the sole.

33. The cross-link claimed in claim 1, the sole comprising a plurality of fasteners to mount the sole to the elongate member.

34. The cross-link claimed in claim 33, the sole comprising polymeric material and a frame member within the polymeric material, the frame member supporting the fasteners.

35. The cross-link claimed in claim 1, the sole comprising:
an inner side for facing the elongate member;
an outer side opposite the inner side for engaging the ground; and
a plurality of blind holes extending from the inner side without reaching the outer side, the sole being mountable to the elongate member via a plurality of fasteners in the blind holes.

36. The cross-link claimed in claim 35, the fasteners being integrated with the sole.

37. (canceled)

38. A sole for a cross-link of a track of a tracked vehicle, the track comprising a plurality of belts spaced apart to accommodate a plurality of wheels of the tracked vehicle, the belts having a ground-facing side for facing the ground, the cross-link comprising an elongate member for mounting to the belts to interconnect the belts, the elongate member having a belt-engaging face contacting the belts on the ground-facing side when the elongate member is mounted to the belts, the elongate member having a length, the sole being mountable to the elongate member, the sole comprising a ground-engaging portion for engaging the ground, the ground-engaging portion of the sole having a length, the length of the ground-engaging portion of the sole being substantially different from the length of the elongate member.

39. The sole claimed in claim 38, wherein the length of the ground-engaging portion of the sole is substantially shorter than the length of the elongate member.

40. The sole claimed in claim 39, wherein a ratio of the length of the ground-engaging portion of the sole to the length of the elongate member is no more than 0.8.

41. (canceled)

42. (canceled)

43. The sole claimed in claim 38, wherein the sole has a length, the length of the sole being substantially different from the length of the elongate member.

44. The sole claimed in claim 43, wherein the length of the sole is substantially shorter than the length of the elongate member.

45. The sole claimed in claim 44, wherein a ratio of the length of the sole to the length of the elongate member is no more than 0.8.

46-48. (canceled)

49. The sole claimed in claim 38, wherein the ground-engaging portion of the sole comprises polymeric material that contacts the ground when the tracked vehicle moves.

50. The sole claimed in claim 49, wherein the polymeric material comprises polyurethane.

51. The sole claimed in claim 49, wherein the polymeric material comprises elastomeric material.

52. The sole claimed in claim 38, wherein the elongate member comprises a bottom portion and a pair of sidewalls extending from the bottom portion, the bottom portion and the sidewalls defining a channel, the sole comprising a base portion located in the channel when the sole is mounted to the elongate member.

53. (canceled)

54. The sole claimed in claim 53, wherein the base portion of the sole comprises a pair of sidewall-engaging surfaces for engaging the sidewalls when the sole is located in the channel, the sidewall-engaging surfaces being generally parallel to one another.

55. The sole claimed in claim 52, wherein the sidewalls have terminating edges, the ground-engaging portion of the sole overlying the terminating edges when the sole is mounted to the elongate member.

56. The sole claimed in claim 52, wherein the ground-engaging portion of the sole is wider than the base portion of the sole.

57. The sole claimed in claim 38, wherein the ground-engaging portion of the sole has a top surface lacking any space in which a rock could become trapped when the ground-engaging portion of the sole contacts the ground.

58. The sole claimed in claim 38, wherein the ground-engaging portion of the sole tapers along a height direction of the sole.

59. The sole claimed in claim 38, comprising a plurality of fasteners to mount the sole to the elongate member.

60. The sole claimed in claim 59, comprising polymeric material and a frame member within the polymeric material, the frame member supporting the fasteners.

61. The sole claimed in claim 38, comprising:
an inner side for facing the elongate member;
an outer side opposite the inner side for engaging the ground; and
a plurality of blind holes extending from the inner side without reaching the outer side, the sole being mountable to the elongate member via a plurality of fasteners in the blind holes.

62. The sole claimed in claim 61, the fasteners being integrated with the sole.

63. (canceled)

64. A cross-link for a track of a tracked vehicle, the track comprising a plurality of belts spaced apart to accommodate a plurality of wheels of the tracked vehicle, the belts having a ground-facing side for facing the ground, the cross-link comprising:
an elongate member for mounting to the belts to interconnect the belts, the elongate member having a belt-engaging face contacting the belts on the ground-facing side when the elongate member is mounted to the belts; and
a sole mountable to the elongate member, the sole comprising a ground-engaging portion for engaging the ground, a ground contact area of the sole being substantially different from a projected area of the elongate member onto the ground.

65. The cross-link claimed in claim 64, wherein the ground contact area of the sole is substantially less than the projected area of the elongate member onto the ground.

66. The cross-link claimed in claim 65, wherein a ratio of the ground contact area of the sole to the projected area of the elongate member onto the ground is no more than 0.9.

67. The cross-link claimed in claim 65, wherein a ratio of the ground contact area of the sole to the projected area of the elongate member onto the ground is no more than 0.8.

68. (canceled)

69. A sole for a cross-link of a track of a tracked vehicle, the track comprising a plurality of belts spaced apart to accommodate a plurality of wheels of the tracked vehicle, the belts having a ground-facing side for facing the ground, the cross-link comprising an elongate member for mounting to the belts to interconnect the belts, the elongate member having a belt-engaging face contacting the belts on the ground-facing side when the elongate member is mounted to the belts, the sole being mountable to the elongate member, the sole comprising a ground-engaging portion for engaging the ground, a ground contact area of the sole being substantially different from a projected area of the elongate member onto the ground.

70. The sole claimed in claim 69, wherein the ground contact area of the sole is substantially less than the projected area of the elongate member onto the ground.

71. The sole claimed in claim 70, wherein a ratio of the ground contact area of the sole to the projected area of the elongate member onto the ground is no more than 0.9.

72. The sole claimed in claim 70, wherein a ratio of the ground contact area of the sole to the projected area of the elongate member onto the ground is no more than 0.8.

73. (canceled)
